(19) United States
(12) Patent Application Publication
(10) Pub. No.: US 2026/0261542 A1
(43) Pub. Date: Sep. 3, 2026

(54) DISTRIBUTED PROCESSING SYSTEM, DISTRIBUTED PROCESSING METHOD, AND PROGRAM

(71) Applicant: Nippon Telegraph and Telephone Corporation, Tokyo (JP)

(72) Inventors: Yuki AKAMATSU, Musashino-shi, Tokyo (JP); Susumu NAKAZAWA, Musashino-shi, Tokyo (JP); Fumihiko SAWAZAKI, Musashino-shi, Tokyo (JP); Kenta Shinohara, Musashino-shi, Tokyo (JP); Takeshi Yamada, Musashino-shi, Tokyo (JP)

(21) Appl. No.: 18/865,893

(22) PCT Filed: May 30, 2022
(86) PCT No.: PCT/JP2022/021994

§ 371 Date: Nov. 14, 2024

(51) Int. Cl. H04L 61/2592

(52) U.S. Cl. CPC H04L 61/2592

(57) ABSTRACT

A communication system includes: a tunnel start point unit disposed at one side of a tunnel through which packets flow; a plurality of tunnel endpoint units disposed at the other side of the tunnel; a distributed processing unit that is disposed in the tunnel and configures a VPN with the tunnel start point unit; and a distributed processing unit that is connected to the plurality of tunnel endpoint units.

### TECHNICAL FIELD

The present invention relates to a distributed processing system, a distributed processing method, and a program.

### BACKGROUND ART

Security Architecture for Internet Protocol (IPsec) is a protocol group for protecting IP communication in a network layer by authenticating/encrypting IP packets of a data stream (Non Patent Literature 1). IPsec provides a falsification detection function and a concealment function in units of IP packets by an encryption technology. By adopting IPsec, it is possible to prevent interception and falsification of communication contents in the middle of a communication path even when a transport layer or an application that does not support encryption is used.

IPsec is often implemented by a dedicated device. However, in order to implement the endpoint processing of IPsec at low cost, there is a method of the endpoint processing by software on a server, such as strongSwan of Non Patent Literature 2.

### CITATION LIST

### Non Patent Literature

Non Patent Literature 1: “IPSRC”, RFC 6071, Internet <URL:https://tex2e.github.io/rfc-translater/html/rfc6071.html>
Non Patent Literature 2: IPsec endpoint software (strongSwan), Internet <URL:https://www.strongswan.org/>

### SUMMARY OF INVENTION

### Technical Problem

A problem to be solved by the present invention will be described with reference to a configuration diagram of a communication system employing IPsec according to a comparative example of FIG. 8.

A communication system 1A includes a tunnel start point unit 31 and a tunnel endpoint unit 32. The tunnel start point unit 31 and the tunnel endpoint unit 32 are configured by, for example, installing IPsec endpoint software on an Intel Architecture (IA) server. An IPsec tunnel 5 is provided between the tunnel start point unit 31 and the tunnel endpoint unit 32. The tunnel start point unit 31 is a functional unit that performs IPsec tunnel start point processing. The tunnel endpoint unit 32 is a functional unit that performs IPsec tunnel endpoint processing.

An opposing device 21 is communicably connected to the tunnel start point unit 31 and communicates with an opposing device 22 via the communication system 1A. The opposing device 22 is communicably connected to the tunnel endpoint unit 32 and communicates with the opposing device 21 via the communication system 1A.

In the communication between the opposing device 21 and the opposing device 22, the communication system 1A establishes the IPsec tunnel 5 between the tunnel start point unit 31 and the tunnel endpoint unit 32. At this time, the tunnel endpoint unit 32 cannot achieve processing performance higher than the processing performance of the IA server constituting the tunnel endpoint unit 32.

In the processing load of the tunnel endpoint processing, the processing load of encryption processing for an authentication header (AH)/encapsulated security payload (ESP) is larger than that of the processing of an internet security association and key management protocol security association (ISAKAMP SA). That is, the limitation of the processing performance of the IA server constituting the tunnel endpoint unit 32 has been the bottleneck of the communication speed of the communication system 1A.

Therefore, an object of the present invention is to distribute the tunnel endpoint processing to a plurality of devices.

### Solution to Problem

In order to solve the above-described problem, according to an aspect of the present invention, there is provided a distributed processing system including: a tunnel start point unit disposed at one side of a tunnel through which packets flow; a plurality of tunnel endpoint units disposed at the other side of the tunnel; a first distributed processing unit that is disposed in the tunnel and configures a VPN with the tunnel start point unit; and a second distributed processing unit that is connected to the plurality of tunnel endpoint units.

Other means will be described in the mode for carrying out the invention.

### Advantageous Effects of Invention

According to the aspect of the present invention, it is possible to distribute the tunnel endpoint processing to a plurality of devices.

### BRIEF DESCRIPTION OF DRAWINGS

FIG. 1 is a diagram illustrating a configuration of a communication system according to the present embodiment.

FIG. 2 is a sequence diagram illustrating pre-authentication of a tunnel endpoint unit.

FIG. 3 is a sequence diagram illustrating key exchange (at a time of connection establishment) by performing endpoint processing on an ISAKMP message of an IKE phase.

FIG. 4 is a diagram illustrating IP address conversion (at a time of encrypted communication) for tunnel formation for AH/ESP in uplink communication.

FIG. 5 is a sequence diagram illustrating IP address conversion (at a time of encrypted communication) for tunnel formation for AH/ESP in uplink communication.

FIG. 6 is a diagram illustrating IP address conversion (at a time of encrypted communication) for tunnel formation for AH/ESP in downlink communication.

FIG. 7 is a sequence diagram illustrating IP address conversion (at a time of encrypted communication) for tunnel formation for AH/ESP in downlink communication.

FIG. 8 is a diagram illustrating a configuration of a communication system employing IPsec according to a comparative example.

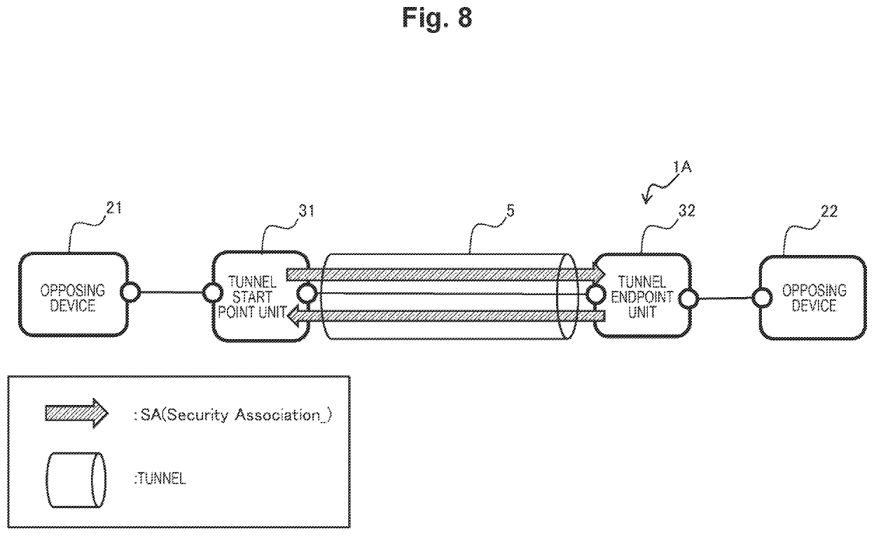

### DESCRIPTION OF EMBODIMENTS

Hereinafter, embodiments for implementing the present invention will be described in detail with reference to the drawings.

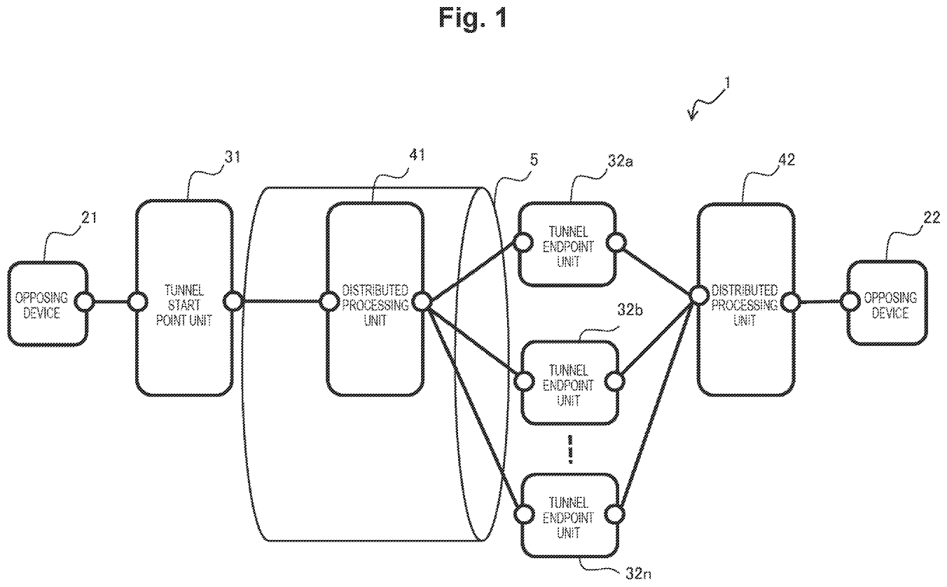

FIG. 1 is a diagram illustrating a configuration of a communication system 1 according to the present embodiment.

The communication system 1 includes a tunnel start point unit 31 and a plurality of tunnel endpoint units 32a, 32b, . . . , and 32n. The tunnel start point unit 31 and a plurality of the tunnel endpoint units 32a, 32b, and 32n are configured by, for example, installing IPsec endpoint software on an IA server, and an IPsec tunnel 5 is provided between the tunnel start point unit 31 and the tunnel endpoint units 32a, 32b, . . . , and 32n.

The tunnel start point unit 31 is a functional unit that performs IPsec tunnel start point processing, and is disposed at one side of the tunnel 5 through which packets flow. A plurality of the tunnel endpoint units 32a, 32b, . . . , and 32n are functional units that perform IPsec tunnel endpoint processing, and are disposed at the other side of the tunnel 5. The tunnel start point unit 31 and a plurality of the tunnel endpoint units 32a, 32b, . . . , and 32n are constructed on the IA server that is a computer, and are embodied by the IA server executing a distributed processing program.

In the communication system 1, a distributed processing unit 41 is further disposed at a preceding stage of a plurality of the tunnel endpoint units 32a, 32b, . . . , and 32n, and a distributed processing unit 42 is disposed at a post stage of a plurality of the tunnel endpoint units 32a, 32b, . . . , and 32n. The distributed processing unit 41 is a first distributed processing unit that is disposed in the tunnel 5 and configures a VPN with the tunnel start point unit 31. The distributed processing unit 42 is a second distributed processing unit connected to a plurality of tunnel endpoint units 32a, 32b, . . . , and 32n.

The communication system 1 improves tunnel endpoint processing performance by distributed processing by adopting an architecture in which a plurality of the tunnel endpoint units 32a, 32b, . . . , and 32n are disposed.

The distributed processing unit 41 may distribute the packets to any of a plurality of the tunnel endpoint units 32a, 32b, . . . , and 32n. The distributed processing unit 41 evenly distributes the packets to a plurality of tunnel endpoint units 32a, 32b, . . . , and 32n by using a distribution method such as round robin. By increasing the number of the tunnel endpoint units 32a, 32b, . . . , and 32n, the tunnel endpoint processing performance of the communication system 1 can be scaled out.

At the time of connection establishment, the distributed processing unit 41 performs endpoint processing on an internet security association and key management protocol (ISAKMP) message which is an internet key exchange (IKE) phase.

The tunnel endpoint units 32a, 32b, . . . , and 32n perform tunnel endpoint processing on AH/ESP. Then, IPsec SA parameters are disposed in the distributed processing unit 41. The tunnel endpoint units 32a, 32b, . . . , and 32n establish a security association (SA) that is a connection with reference to the IPsec SA parameters disposed in the distributed processing unit 41.

Here, an AH protocol is a protocol for performing packet integrity check. An ESP protocol encrypts packet data and optionally performs integrity check. This can prevent interception and falsification. In the communication system 1 of the present embodiment, communication is protected in an IPsec tunnel mode between the tunnel start point unit 31 and the tunnel endpoint units 32a, 32b, . . . , and 32n.

The distributed processing units 41 and 42 are distribution units of distributing AH/ESP packets to a plurality of the tunnel endpoint units 32a, 32b, . . . , and 32n. Furthermore, the distributed processing units 41 and 42 perform endpoint processing on the ISAKMP message. Moreover, the distributed processing units 41 and 42 are functional units that rewrite a temporary destination IP address where the tunnel start point unit 31 establishes a VPN endpoint as an endpoint IP address to any one of the destination IP addresses of a plurality of the tunnel endpoint units 32a, 32b, . . . , and 32n.

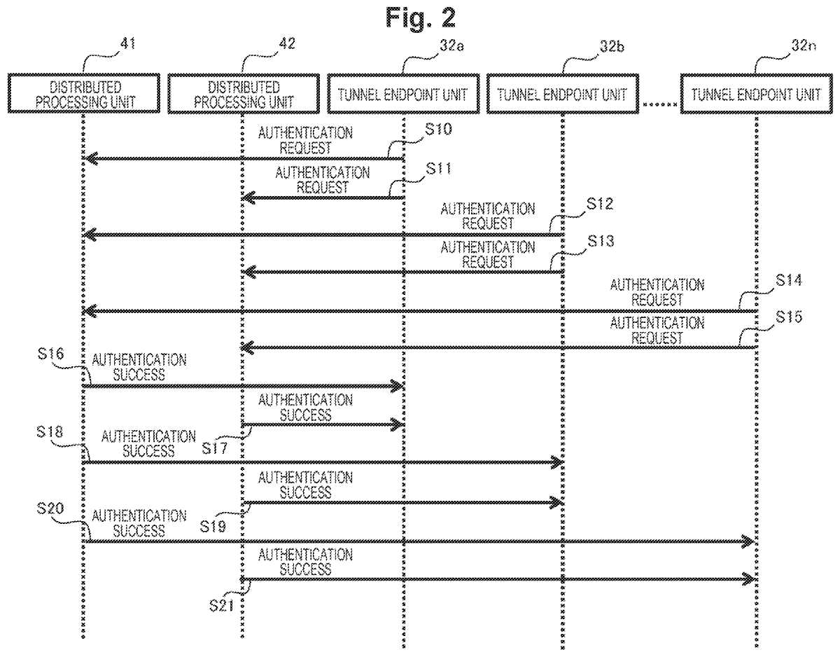

FIG. 2 is a sequence diagram illustrating pre-authentication of the tunnel endpoint units 32a, 32D, . . . , and 32n.

The distributed processing units 41 and 42 authenticate a plurality of the tunnel endpoint units 32a, 32b, . . . , and 32n which are communication partners in advance.

Specifically, the tunnel endpoint unit 32a transmits an authentication request to the distributed processing unit 41 (step S10), and transmits an authentication request to the distributed processing unit 42 (step S11). Specifically, the tunnel endpoint unit 32b transmits an authentication request to the distributed processing unit 41 (step S12), and transmits an authentication request to the distributed processing unit 42 (step S13). As described above, the tunnel endpoint unit 32n transmits an authentication request to the distributed processing unit 41 (step S14), and transmits an authentication request to the distributed processing unit 42 (step S15).

Next, the distributed processing unit 41 transmits information regarding authentication success to the tunnel endpoint unit 32a (step S16). The distributed processing unit 42 transmits information regarding authentication success to the tunnel endpoint unit 32a (step S17). The distributed processing unit 41 transmits information regarding authentication success to the tunnel endpoint unit 32b (step S18). The distributed processing unit 42 transmits information regarding authentication success to the tunnel endpoint unit 32b (step S19). As described above, the distributed processing unit 41 transmits information regarding authentication success to the tunnel endpoint unit 32n (step S20). The distributed processing unit 42 transmits information regarding authentication success to the tunnel endpoint unit 32n (step S21).

After the authentication, the distributed processing units 41 and 42 perform communication only for those authenticated in advance among the tunnel endpoint units 32a, 32b, . . . , and 32n.

The authentication in the distributed processing units 41 and 42 and a plurality of the tunnel endpoint units 32a, 32b, . . . , and 32n may be performed, for example, with radius in the existing technology, or may be performed with Diameter.

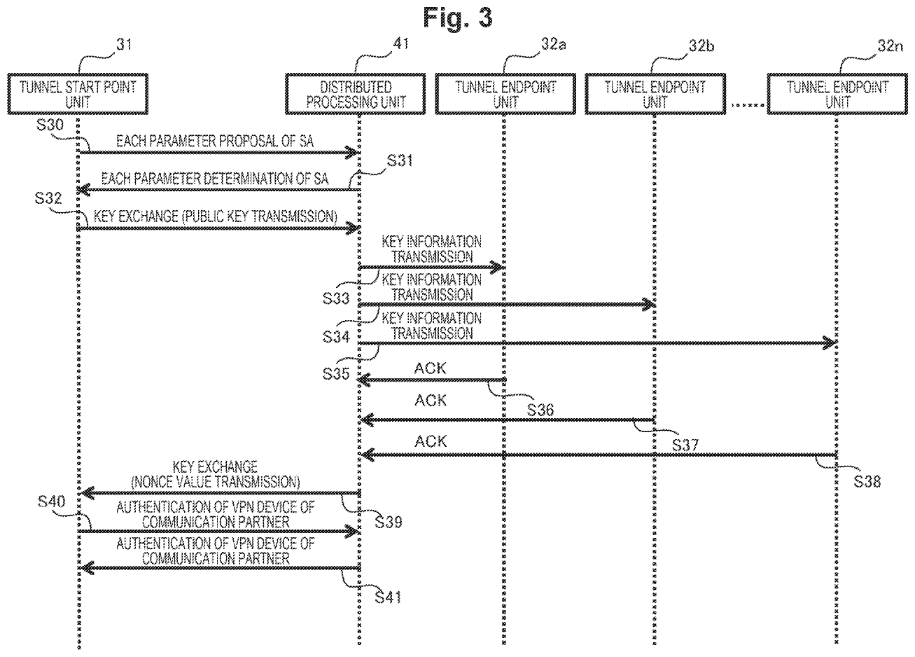

FIG. 3 is a sequence diagram illustrating key exchange (at a time of connection establishment) by performing endpoint processing on an ISAKMP message of an IKE phase.

The tunnel start point unit 31 transmits each parameter proposal of the SA to the distributed processing unit 41 (step S30). Then, when each parameter of the SA is determined, the distributed processing unit 41 transmits each determined parameter of the SA to the tunnel start point unit 31 (step S31). The tunnel start point unit 31 transmits a public key to the distributed processing unit 41 (step S32).

Next, the distributed processing unit 41 transmits key information to the tunnel endpoint unit 32a (step S33), and transmits the key information to the tunnel endpoint unit 32b (step S34). As described above, the distributed processing unit 41 transmits the key information to the tunnel endpoint unit 32n (step S35).

Then, the tunnel endpoint unit 32a transmits ACK (positive response) to the distributed processing unit 41. (step S36). The tunnel endpoint unit 32b transmits the ACK (positive response) to the distributed processing unit 41 (step S37). As described above, the tunnel endpoint unit 32n transmits the ACK (positive response) to the distributed processing unit 41 (step S38).

The distributed processing unit 41 transmits a nonce value to the tunnel start point unit 31 to exchange keys (step S39). Here, the nonce value corresponds to the value of a secret key.

The tunnel start point unit 31 authenticates the distributed processing unit 41 as the VPN device of the communication partner (step S40). The distributed processing unit 41 authenticates the tunnel start point unit 31 as the VPN device of the communication partner (step S41).

Here, the distributed processing unit 41 performs endpoint processing on the ISAKMP message. Moreover, the distributed processing unit 41 establishes a connection with a plurality of the tunnel endpoint units 32a, 32b, . . . , and 32n.

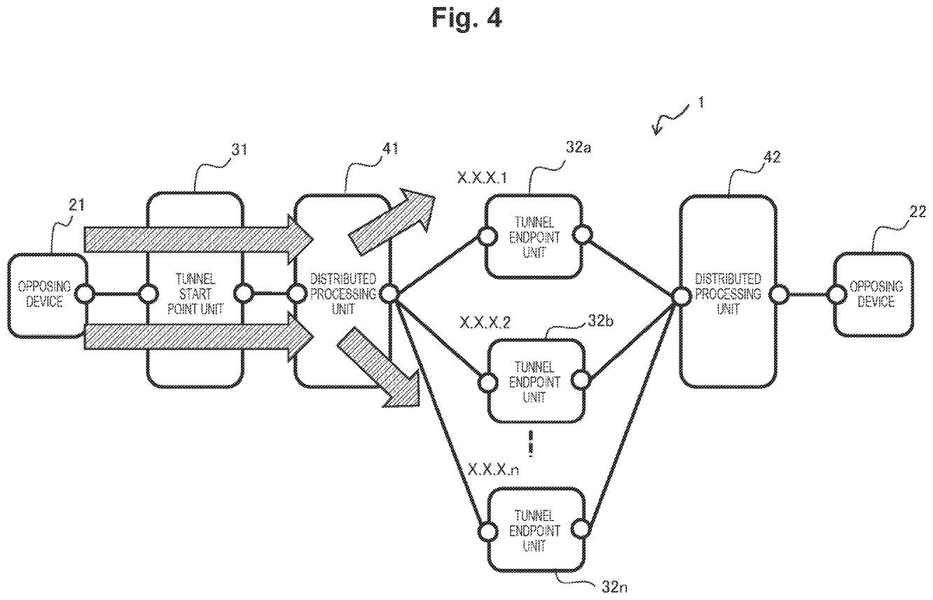

FIG. 4 is a diagram illustrating IP address conversion (at a time of encrypted communication) for tunnel formation for AH/ESP in uplink communication.

The tunnel start point unit 31 establishes a VPN endpoint with a temporary destination IP address X.X.X.X.254 as an endpoint IP address.

The distributed processing unit 41 sequentially converts the temporary destination IP address X.X.X.X.254 into IP addresses X.X.X.X.1, X.X.X.X.2, . . . , and X.X.X.n of a plurality of the tunnel endpoint units 32a, 32b, . . . , and 32n, and sequentially transfers the packets to a plurality of the tunnel endpoint units 32a, 32b, . . . , and 32n.

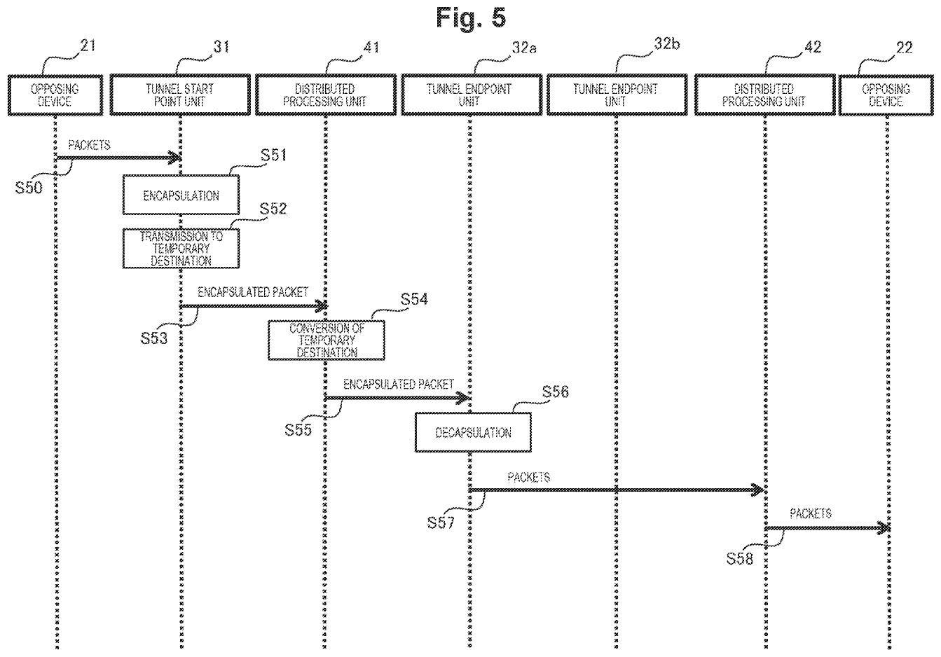

FIG. 5 is a sequence diagram illustrating IP address conversion (at a time of encrypted communication) for tunnel formation for AH/ESP in uplink communication.

First, the opposing device 21 transmits packets to the tunnel start point unit 31 (step S50). The tunnel start point unit 31 encrypts the packets and then encapsulates the encrypted packets, sets the temporary destination IP address X.X.X.X.254, and transfers the encapsulated packet (step S52).

The encapsulated packet is transmitted from the tunnel start point unit 31 to the distributed processing unit 41. The distributed processing unit 41 sequentially converts the temporary destination IP address X.X.X.X.254 of the encapsulated packet into IP addresses X.X.X.X.1, X.X.X.X.2, . . . , and X.X.X.n of a plurality of the tunnel endpoint units 32a, 32b, . . . , and 32n (step S54). Here, the encapsulated packet is transmitted from the distributed processing unit 41 to the tunnel endpoint unit 32a (step S55). Note that the distributed processing unit 41 transmits the encapsulated packet to a plurality of the tunnel endpoint units 32a, 32b, . . . , and 32n, for example, in round robin.

The tunnel endpoint unit 32a decodes and decapsulates the encapsulated packet (step S56). Thereafter, the tunnel endpoint unit 32a transmits packets to the distributed processing unit 42 (step S57). The distributed processing unit 42 relays the packets to the opposing device 22 (step S58).

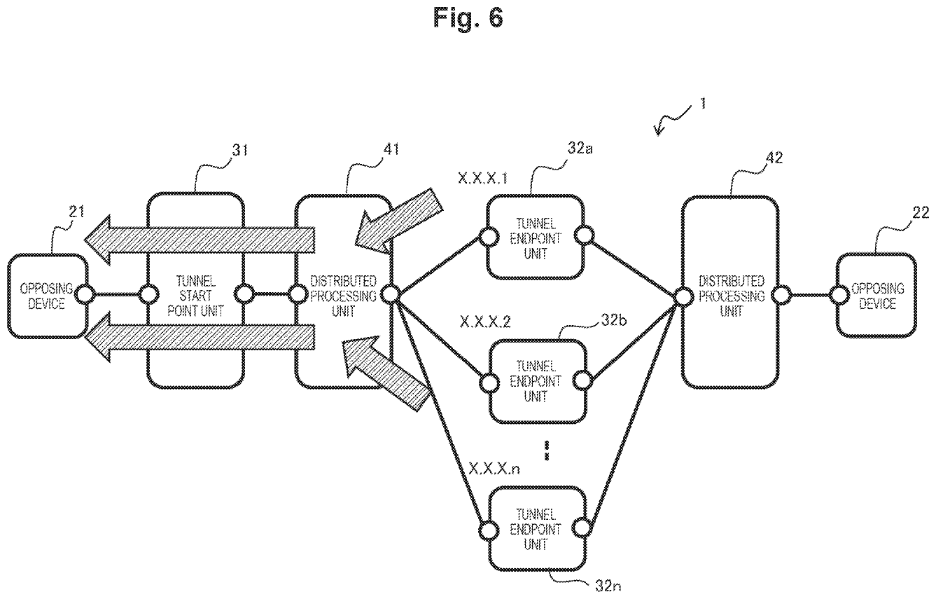

FIG. 6 is a diagram illustrating IP address conversion (at a time of encrypted communication) for tunnel formation for AH/ESP in downlink communication.

The distributed processing unit 41 converts source IP addresses X.X.X.X.1, X.X.X.X.2, . . . , and X.X.X.n into the temporary destination IP address X.X.X.254. Thus, the communication system 1 transfers the packets while maintaining a state in which the tunnel start point unit 31 establishes the temporary destination IP address X.X.X.254 and the VPN endpoint.

When the packets are encrypted in the tunnel endpoint units 32a, 32b, . . . , and 32n, the packets are encrypted on the basis of the IPsec parameters of the distributed processing unit 41. Thus, the same IP address X.X.X.254 is encrypted as the source address in all the tunnel endpoint units 32a, 32b, . . . , and 32n.

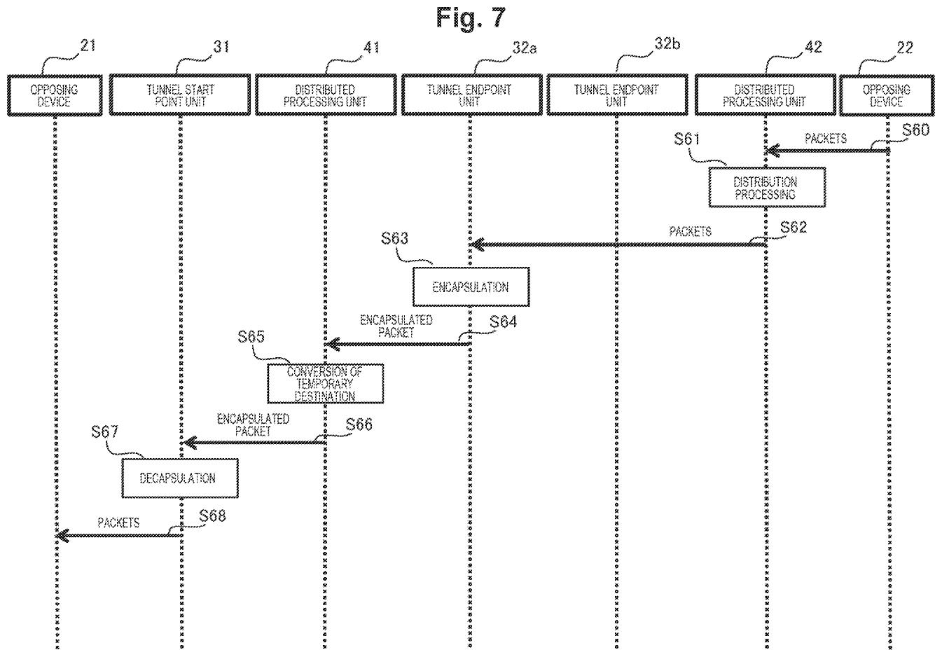

FIG. 7 is a sequence diagram illustrating IP address conversion (at a time of encrypted communication) for tunnel formation for AH/ESP in downlink communication.

First, the opposing device 22 transmits packets to the distributed processing unit 42 (step S60). The distributed processing unit 42 performs distribution processing (step S61) and transfers packets to any one of a plurality of the tunnel endpoint units 32a, 32b, . . . , and 32n (step S62). The distribution processing is, for example, round robin. Here, the distributed processing unit 42 transmits the packets to the tunnel endpoint unit 32a (step S62).

The tunnel endpoint unit 32a encrypts the packets and then encapsulates the encrypted packets (step S63), and transmits the encapsulated packet to the distributed processing unit 41 (step S64). When the source IP address X.X.X.X.1 is converted into the temporary source IP address X.X.X.X.254 (step S65), the distributed processing unit 41 relays the encapsulation packet to the tunnel start point unit 31 (step S66).

The tunnel start point unit 31 decapsulates and decodes the packet (step S67), and then relays the packet to the opposing device 21 (step S68).

### Effects From Invention

The tunnel endpoint processing performance can be improved by distributing and processing the tunnel endpoint processing required by the SA which is one connection of IPsec.

### Point of Invention

The present invention realizes scale-out of the tunnel endpoint unit by disposing the distributed processing units 41 and 42.

The present invention has a configuration in which the endpoint processing on the ISAKMP message that is an IKE phase is performed by the distributed processing unit 41, and the tunnel endpoint processing of AH/ESP is performed by a plurality of the tunnel endpoint units 32a, 32b, . . . , and 32n.

The present invention has a configuration in which the IPsec SA parameters are assigned to the distributed processing unit 41 and are referred to from the tunnel endpoint units 32a, 32b, . . . , and 32n.

The present invention has a configuration in which in the uplink communication, the distributed processing unit 41 rewrites the temporary destination IP address where the tunnel start point unit 31 establishes a VPN endpoint as an endpoint IP address to the destination IP addresses of a plurality of the tunnel endpoint units 32a, 32b, . . . , and 32n.

The present invention has a configuration in which in the downlink communication, the distributed processing unit 41 rewrites the IP addresses of a plurality of the tunnel endpoint units 32a, 32b, . . . , and 32n to the temporary destination IP address where the tunnel start point unit 31 establishes the VPN endpoint as the endpoint IP address.

### Modification Example

The present invention is not limited to the embodiment described above, and can be modified without departing from the gist of the present invention. For example, there are the following (a) to (c).
(a) The temporary destination IP address X.X.X.254 is an example, and an arbitrary address may be selected.
(b) The ESP protocol is an example. The present invention may be implemented by the AH protocol.
(c) In the above-described embodiment, the endpoint processing of the tunnel 5 is distributed, but the start point processing of the tunnel 5 may be distributed.

### Effects

Hereinafter, the effects of the distributed processing system and the like according to the present invention will be described.

### Claim 1

A distributed processing system including:
a tunnel start point unit disposed at one side of a tunnel through which packets flow;
a plurality of tunnel endpoint units disposed at the other side of the tunnel;
first distributed processing unit that is disposed in the tunnel and configures a VPN with the tunnel start point unit; and
a second distributed processing unit that is connected to the plurality of tunnel endpoint units.

With this configuration, it is possible to distribute the tunnel endpoint processing to a plurality of devices.

### Claim 2

The distributed processing system according to claim 1, in which
the first distributed processing unit distributes packets to the plurality of tunnel endpoint units.

With this configuration, it is possible to distribute the tunnel endpoint processing to a plurality of devices.

### Claim 3

The distributed processing system according to claim 1, in which
the first distributed processing unit performs endpoint processing on an ISAKMP message.

With this configuration, the endpoint processing using the same key can be performed at a plurality of the tunnel endpoint units.

### Claim 4

The distributed processing system according to any one of claims 1 to 3, in which
the first distributed processing unit converts a destination IP address of the packets from a temporary IP address establishing a VPN endpoint into an IP address of any of the tunnel endpoint units in relaying the packets to the tunnel endpoint units.

With this configuration, it is possible to distribute the tunnel endpoint processing on uplink packets to a plurality of devices.

### Claim 5

The distributed processing system according to any one of claims 1 to 3, in which
the first distributed processing unit converts a source address of the packets from an IP address of any of the tunnel endpoint units into a temporary IP address establishing a VPN endpoint in relaying the packets to the tunnel start point unit.

With this configuration, it is possible to distribute the tunnel endpoint processing on downlink packets to a plurality of devices.

### Claim 6

The distributed processing system according to any one of claims 1 to 3, in which
the second distributed processing unit relays packets to any of the plurality of tunnel endpoint units.

With this configuration, it is possible to distribute the tunnel endpoint processing to a plurality of devices.

### Claim 7

A program for causing a computer disposed in a tunnel through which packets flow to execute:
a procedure of configuring a VPN with a tunnel start point unit disposed at one side of the tunnel; and
a procedure of converting a destination IP address of the packets received from the tunnel start point unit from a temporary IP address establishing a VPN endpoint into an IP address of any of tunnel endpoint units disposed at the other side of the tunnel.

With this configuration, it is possible to distribute the tunnel endpoint processing to a plurality of devices.

### Claim 8

A distributed processing method including:
a step of causing a distributed processing unit disposed in a tunnel through which packets flow to configure a VPN with a tunnel start point unit disposed at one side of the tunnel; and
a step of converting a destination IP address of the packets received from the tunnel start point unit from a temporary IP address establishing a VPN endpoint into an IP address of any of tunnel endpoint units disposed at the other side of the tunnel.

With this configuration, it is possible to distribute the tunnel endpoint processing to a plurality of devices.

### REFERENCE SIGNS LIST

1 Communication system (distributed processing system)
1A Communication system
31 Tunnel start point unit
32 Tunnel endpoint unit
32a, 32b, 32n Tunnel endpoint unit
5 Tunnel
21 Opposing device
22 Opposing device
41 Distributed processing unit (first distributed processing unit)
42 Distributed processing unit (second distributed processing unit)

1. A distributed processing system comprising:
a tunnel start point unit, including one or more processors, disposed at one side of a tunnel through which packets flow;
a plurality of tunnel endpoint units, including one or more processors, disposed at the other side of the tunnel;
a first distributed processing unit, including one or more processors, that is disposed in the tunnel and configures a VPN with the tunnel start point unit; and
a second distributed processing unit, including one or more processors, that is connected to the plurality of tunnel endpoint units.

2. The distributed processing system according to claim 1, wherein
the first distributed processing unit is configured to distribute packets to the plurality of tunnel endpoint units.

3. The distributed processing system according to claim 1, wherein
the first distributed processing unit is configured to perform endpoint processing on an ISAKMP message.

4. The distributed processing system according to claim 1, wherein
the first distributed processing unit is configured to convert a destination IP address of the packets from a temporary IP address establishing a VPN endpoint into an IP address of any of the tunnel endpoint units in relaying the packets to the tunnel endpoint units.

5. The distributed processing system according to claim 1, wherein
the first distributed processing unit is configured to convert a source address of the packets from an IP address of any of the tunnel endpoint units into a temporary IP address establishing a VPN endpoint in relaying the packets to the tunnel start point unit.

6. The distributed processing system according to claim 1, wherein
the second distributed processing unit is configured to relay packets to any of the plurality of tunnel endpoint units.

7. A program for causing a computer disposed in a tunnel through which packets flow to execute:
configuring a VPN with a tunnel start point unit disposed at one side of the tunnel; and
converting a destination IP address of the packets received from the tunnel start point unit from a temporary IP address establishing a VPN endpoint into an IP address of any of tunnel endpoint units disposed at the other side of the tunnel.

8. A distributed processing method comprising:
causing a distributed processing unit disposed in a tunnel through which packets flow to configure a VPN with a tunnel start point unit disposed at one side of the tunnel; and
converting a destination IP address of the packets received from the tunnel start point unit from a temporary IP address establishing a VPN endpoint into an IP address of any of tunnel endpoint units disposed at the other side of the tunnel.
